(19) United States
(12) Patent Application Publication
(10) Pub. No.: US 2015/0186751 A1
(43) Pub. Date: Jul. 2, 2015

(54) IMAGE DUPLICATION DETECTION

(71) Applicant: Stake Center Locating, Inc., Salt Lake City, UT (US)

(72) Inventor: David B. Mosier, Clearfield, UT (US)

(73) Assignee: Stake Center Locating, Inc., Salt Lake City, UT (US)

(21) Appl. No.: 14/145,392

(22) Filed: Dec. 31, 2013

(51) Int. Cl. G06K 9/62; G06F 17/30; G06K 9/46

(52) U.S. Cl. CPC G06K 9/6215; G06K 9/6202; G06K 9/4652; G06F 17/3028; G06F 17/3025

(57) ABSTRACT

Systems and methods for identifying duplicate images or duplicate data.

### CROSS-REFERENCE TO RELATED APPLICATIONS

This application is related to U.S. patent application Ser. No. 14/______, entitled LOCATE TICKET MANAGEMENT (attorney docket no. 20062.1), and filed the same day herewith. The aforementioned application is incorporated by reference in its entirety.

### BACKGROUND OF THE INVENTION

Devices (e.g., smartphones, laptop computers, tablet devices) in use today are capable of generating images in various forms. Devices can take photographs and video images for example. As the capabilities of these devices advance, the images generated by these devices often have large sizes and high resolutions.

Because images are becoming increasingly common, there are situations where it may be desirable to determine whether or not one image is a duplicate of another image. One way to determine whether an image is a duplicate of another image is to directly compare the two images. Because these images can be large in size, this process can require significant computing resources. Comparing each pixel in each image can consume computing resources. The computation requirement becomes even larger when the image is compared with multiple images. For example, determining whether an image already exists in a large repository of images can quickly become computationally prohibitive.

In one example, a file may be hashed and the hash may be used as a fingerprint to uniquely identify the file. However, if a single pixel is edited or if the file is resaved with a different name, the hash may change. As a result, a hash of the file may have pitfalls in some instances. Systems and methods are needed to more quickly identify duplicate images.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 illustrates an example of an environment for implementing systems and methods for determining whether an image is a duplicate of another image;

FIG. 2 illustrates an example of an image and of a method for processing the image for entry into a duplication database; and

FIG. 3 illustrates an example of a method for determining whether an image is a duplicate of another image.

### DETAILED DESCRIPTION

Embodiments of the invention relate to systems and methods for identifying duplicate images. Embodiments of the invention enable a server or other device to quickly determine whether an image is a duplicate of another image that may be stored in an image repository. Embodiments of the invention generate a signature from an image. The signature can be compared against other signatures that have been generated from other images to determine whether the image is a duplicate image. Embodiments of the invention enable a large number of signatures (each signature may be a record or an entry in a database, for example) to be evaluated quickly. Comparing an image's signature to signatures in a database can be performed much more quickly than comparing the image to a database of images. In addition, significantly less storage space is required. By way of example, 1 million records can be accommodated in less than 100 MB.

Embodiments of the invention divide an image into areas or sections and then generate at least one value for each area or section. These values may depend on pixel values, hash values of the pixels (generating a hash of the pixels is distinct from generating a hash of the file), or the like. Each area may have one or more associated values. The values of all areas or sections may constitute an example of the image's signature. As a result, whether an image is a duplicate can be determined by comparing the image's signature with the signatures of other images. Because the amount of data being compared is considerably smaller than the size of the image, the comparison is significantly faster and can be performed for a significantly larger number of images in less time.

In addition to the values generated from the image, the signature may also include other information about the image. For example, the size, a date, a location of the image, the device that generated the image, or the like or any combination thereof may also be part of the signature of the image. However, the signature may only include an average pixel value (or other value) for each area.

Embodiments of the invention can be implemented into workflows that require the use of images or that require images to be generated. For example, employees that perform a job may be required to take an image (picture) of the work product when the job is completed or performed. This image that is provided by an employee (e.g., when the employee uploads the image to a server) can be processed to generate the image's signature. The image's signature can then be compared to determine whether the image is a duplicate of another image. If the image is determined to be a duplicate, this could suggest that the wrong image was submitted. It could also be used to determine whether a particular job was completed. The ability to quickly determine the validity of the image ensures that an entity can provide better service and ensure that the work performed by the entity has actually been performed. A photograph may be used as proof of completion and ensuring that the photograph is not a duplicate helps ensure that the photograph represents what it is purported to represent.

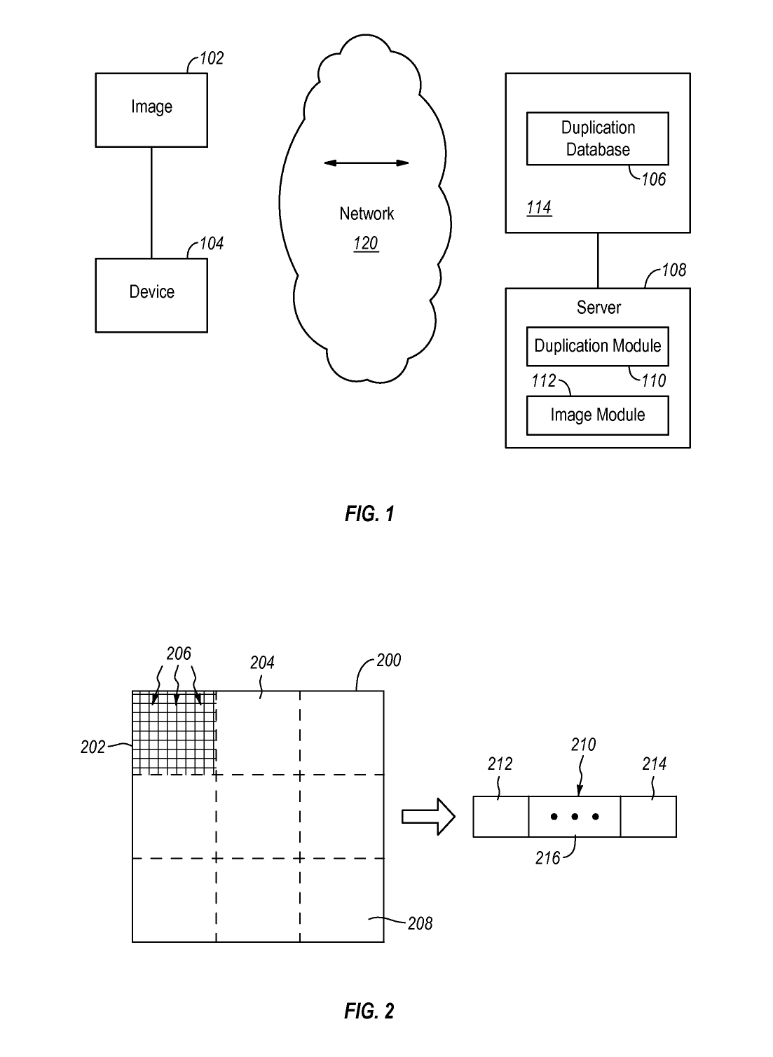

FIG. 1 illustrates an example of an environment for implementing embodiments of the invention. FIG. 1 illustrates an environment 100 that includes a network 120. The network 120 may be a local area network, a wide area network, the Internet, or the like or any combination thereof and may include wired and/or wireless networks. The transfer of data in the network 120 may use any suitable protocol and may use different protocols. For example, a data transmission (e.g., sending an image) may originate on a cellular network and arrive at another type of network.

Embodiments of the invention are not limited to image data, but may also be applied to other data types and configurations.

FIG. 1 illustrates a device 104 that is capable of generating an image 102. The device 104 may be a smart phone, a camera, a video device, a tablet device, or the like or any combination thereof. The image 102 may be initially stored on the device 104, may be transmitted to another device over the network 120, may be stored temporarily on the device 104, or the like.

In one example, the image 102 is transmitted to a server 108 over the network 120. The image 108 may be transmitted to the server 108 over the air when the image 102 is generated or taken. Alternatively, the image 102 may be uploaded to the server 108 at a later time, for example when the device is docked. The server 108 may be inside a local network or part of a private network.

The server 108 can store the image 102 and/or metadata and/or a signature generated from the image 102 in a duplication database 106 that is stored in a memory 114, such as a hard disk or other storage device. In one example, the signature is a certain example of metadata and may, in some examples, include other metadata associated with the image.

The duplication database 106 may be configured to store images or other data (e.g., video images, document images), metadata of the images or associated with the images, or the like or combination thereof. In one example, it is not necessary to store images in the duplication database 106 to determine whether the image 102 is a duplicate of an already existing image. In fact, the duplication database 106 may store signatures and the actual images may be stored in another location or storage device. The database may store the signature generated from the image as well as information identifying where the image is actually stored (e.g., in another database or storage device).

As a result, images may be included in the duplication database 106 or stored separately from the duplication database 16. When stored separately, the signatures stored in the duplication database may be linked to the images such that the images associated with the signatures can be retrieved or displayed if necessary. Once both images are displayed (the image being evaluated and the image that may be a duplicate), the image and the potential duplicate can be further evaluated by a person if desired.

When an image is received at the server 108, an image module 112 may operate to process the image 102 and enter the image 102 and/or associated signature into the duplication database 106. In one example, the signature generated by the image module 112 is stored in the duplication database 106 and may be used by the duplication module 110 to determine whether the image 102 is a duplicate of an image that has already been entered into the duplication database 106. In one example, the duplication can be determined using only the signature. As previously stated, this enables the duplication database to store a large number of records while consuming comparatively small disk space.

The duplication module 110 may compare the signature of the image 102 with signatures stored in the duplication database 106 to determine whether the image 102 is a duplicate of another image. In a workflow, each image received from the device 104 (or from other devices associated with the server 108) may be evaluated to determine whether they are duplicate images. In one example, the method of determining whether an image taken by the device 104 is a duplicate can be focused on images that were previously taken by the device 104. This may also shorten the method of determining whether an image is a duplicate image.

FIG. 2 illustrates an example of an image that is processed by the image module 112 for entry into the duplication database 106. More specifically, FIG. 2 illustrates an example of a signature that is generated from an image and that can be stored in a duplication database.

FIG. 2 illustrates an image 200, which is an example of the image 102. When the image 200 is received, the image 200 may be scaled down to a certain size, although the reduction in size can be optional). Scaling the image 200 down to a certain size can reduce processing requirements. The image 200 is then divided into sections or areas (nine in this example, although the number of areas or sections could be different), represented by the area 202, 204, and 208. Each of the areas in the image 200 includes pixels, represented by the pixels 206. Further, the areas of the image 200 are typically the same size. When comparing one image (or its signature) to another image (or its signature), both images should have been divided into the same sections or areas.

The number of areas the image 200 is divided into can vary. In order to identify duplicate images, however, it is advantageous to scale all images to the same size or resolution and then divide all images into the same number of areas that are of the same size. In some example, the images may be rotated, cropped, or the like prior to scaling. Further, the same scaling process may be used.

In one embodiment, a duplicate image may be identified from image portions. In this example, a portion of an image (the rest of the image may be cropped and may be discarded) may be scaled and divided into areas. In addition, the images received by the server may first be oriented in a particular orientation. Also, the portion of the image used for duplication detection may be the same portion of the image (e.g., the upper left portion or the like).

In one example, the areas (or sections) of the image 200 are evaluated and at least one value is determined or generated for each area. For example, the pixels 206 in the area 202 are sampled to determine red, green, and blue values (RGB values for each pixel). The values for all the pixels 206 are averaged together to result in an average value for the area 202. The value may a single value that is an average of all RGB values. Alternatively, the value may include an average red value, an average blue value, and an average green value. The other areas of the image 200 are similarly processed to obtain corresponding values.

The resulting values are stored in an image string 216. The string 216 contains, in one example, values for each of the areas in the image 200. For example the portion 212 of the string 216 contains the value (e.g., the average pixel value or average pixel values) for the area 202. The portion 214 contains the value associated with the area 208. The portions 210 contain the values for other areas in the image 200. A duplicate video could be identified using the methods discussed herein by storing values for a particular frame or values for a series of frames. In one example, the signature may be a series of values that are generated from an image. The series of values are selected such that they have a high likelihood of being unique. As long as duplicate images can be generated with sufficient accuracy, the values in the signature can be average pixel values, hash values of only pixels, or the like or any combination thereof.

The string 216 is an example of signature (e.g., a pixel signature) that may be stored in the duplication database 106. The string 216 generated from the image 200 may be compared to similar signatures already stored in the duplication database 106. If a match is found, then the image 200 may be a duplicate of another image that has already been processed and stored. The string 216 is typically much smaller in size than the image 200 and consumes less space.

In one example, the image 200 is scaled to have a size of 640×480. One of skill in the art can appreciate that other sizes are possible. Further, the image 200 may be divided into 9 sections or areas. As a result, each area may have a size on the order of about 213×160 pixels. The areas do not need to be the same size. However, all images should be divided into the same corresponding areas such that the values generated from these areas can be confidently compared. For an area having 213×160 pixels wherein each pixel has a blue value, a red value, and a green value and where each RGB value may be described by 16 or 32 bits or 64 bits (or other number), for example, the average value of the pixels for a given area is likely to be unique. Determining an average value for or the average values for all sections of a 640×480 image is less intensive than determining an average value for or the average values for all sections of a 1280×920 image for a higher resolution image. As a result, the image may be scaled although scaling the image to a lower resolution may be optional.

In addition, because the string or signature contains values for several areas, it is even more likely that the string or the signature can be used to uniquely identify the image and provides high confidence when a match is discovered.

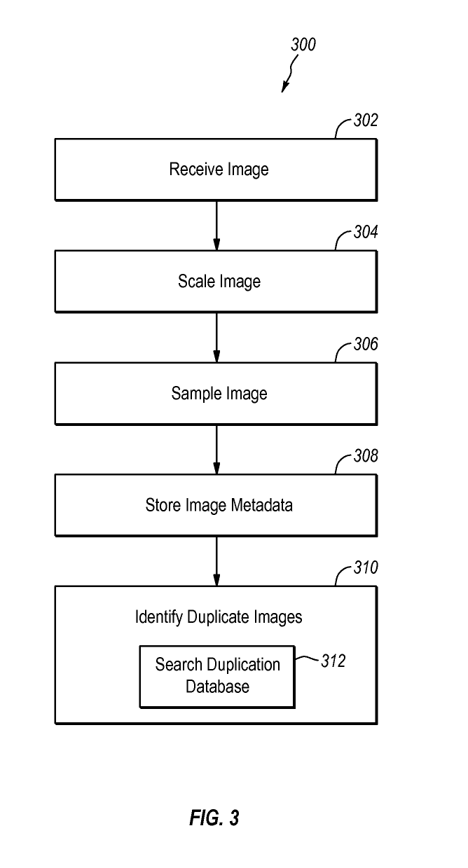

FIG. 3 is a flow diagram illustrating an example of a method for identifying a duplicate image. The method 300 may begin by receiving an image in block 300. An image may be received from a device. In fact, multiple images may be received from multiple locations and multiple devices.

After the image is received, the method 300 includes scaling the image in block 304. The received image may be scaled to reduce processing times. In one example, the received image is scaled to an image size of 640×480. For example, an image size of 640×480 can be processed more quickly than an image having a larger resolution.

Next, the method includes sampling the image in block 306. Sampling the image can include sampling each section or area into which the image has been divided. In one example, sampling the image can include dividing the image into sections or areas. Once the image has been divided into areas, each area may be sampled or evaluated independently of other areas or sections. Sampling each area can include determining a value for each value. The value may be an average pixel value, a hash value (e.g., a hash value of only the pixels), or other value that is computed from the pixels in the area or the like or combination thereof. As a result, sampling the image or an area of the image can result in a single value for each area.

After the value or values for each area in the image have been determined, the values may be stored in, by way of example, a string or in another format. The string generated from the image is an example of a signature. The signature may then be stored in the duplication database in block 308 However, it may not be necessary to store the signature of an image in the duplication database in order to determine whether the image is a duplicate. Rather, the generated signature can be compared to the signatures stored in the duplication database. If the image that has been received is a duplicate, it may not be stored in the database and may be rejected. In this example, the method may include requesting another photograph or image.

In block 310, the method 300 includes identifying duplicate images. Identifying duplicate images can include searching the duplication database 312 based on the signature generated from the image being evaluated. The image being evaluated can be a newly received image or an existing image. The duplication database can be searched using, for example, one of the values in the signature.

Identifying duplicate images is performed by comparing the signature of an image with previously generated image signatures.

For example, the image generated by a particular device can be compared by generating a signature from the image and then comparing that signature with signatures generated from other images taken by that device or by other devices. In one example, embodiments of the invention enable the server (or the entity or device evaluating the image) to determine whether the image is new or whether the device is resubmitting (whether on accident or on purpose) a previously generated image. Embodiments of the invention can therefore ensure that a given job (where an image is generated) is performed and that the image reflects that job or task.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein.

As indicated above, embodiments within the scope of the present invention also include computer storage media, which are physical media for carrying or having computer-executable instructions or data structures stored thereon. Such computer storage media can be any available physical media that can be accessed by a general purpose or special purpose computer.

By way of example, and not limitation, such computer storage media can comprise hardware such as solid state disk (SSD), RAM, ROM, EEPROM, CD-ROM, flash memory, phase-change memory (“PCM”), or other optical disk storage, magnetic disk storage or other magnetic storage devices, or any other hardware storage devices which can be used to store program code in the form of computer-executable instructions or data structures, which can be accessed and executed by a general-purpose or special-purpose computer system to implement the disclosed functionality of the invention. Combinations of the above should also be included within the scope of computer storage media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ can refer to software objects or routines that execute on the computing system. The different components, modules, engines, and services described herein may be implemented as objects or processes that execute on the computing system, for example, as separate threads. While the system and methods described herein can be implemented in software, implementations in hardware or a combination of software and hardware are also possible and contemplated. In the present disclosure, a ‘computing entity’ may be any computing system as previously defined herein, or any module or combination of modulates running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention can be performed in client-server environments, whether network or local environments, or in any other suitable environment. Suitable operating environments for at least some embodiments of the invention include cloud computing environments where one or more of a client or server may reside and operate in a cloud environment.

Finally, those skilled in the art will appreciate that the invention may be practiced in network computing environments with many types of computer system configurations, including, personal computers, desktop computers, laptop computers, tablets, message processors, hand-held devices, multi-processor systems, microprocessor-based or programmable consumer electronics, network PCs, minicomputers, mainframe computers, mobile telephones, PDAs, pagers, routers, switches, underground object sensors, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for identifying duplicate images, the method comprising:
receiving an image from a device;
sampling the image to generate a signature for the image;
comparing the signature to other signatures stored in a database, wherein the other signatures are associated with other images; and
determining that the image is a duplicate when the signature matches one of the other signatures stored in the database.

2. The method of claim 1, wherein sampling the image comprises dividing the image into a plurality of areas.

3. The method of claim 2, wherein sampling the image further comprises determining a value for each of the plurality of areas, wherein the signature includes each value for each of the plurality of areas.

4. The method of claim 3, wherein the signature comprises a string and wherein sampling the image further comprises storing the value for each of the areas in the string.

5. The method of claim 4, further comprising storing the string in the database.

6. The method of claim 5, further comprising storing the image in the database or in a location separate from the database.

7. The method of claim 6, wherein the string is associated with the image such that the image can be retrieved when the string is selected.

8. The method of claim 1, further comprising resizing the image to a lower resolution.

9. The method of claim 1, wherein the database only stores signatures of images and locations of the images associated with the signatures, wherein the locations are associated with the signatures such that each signature identifies a location of the corresponding image.

10. The method of claim 1, wherein the signature includes at least one average pixel value.

11. The method of claim 10, wherein the image is divided into a plurality of areas and wherein the signature includes at least one average pixel value for each of the plurality of areas.

12. The method of claim 11, wherein the at least one average pixel value for each area is an average of all pixel values in each area.

13. The method of claim 12, wherein the at least one average pixel value includes an average pixel value for blue, an average pixel value for red, and an average pixel value for green.

14. The method of claim 1, wherein the image is divided into a plurality of areas and wherein the signature includes at least one hash value for each of the plurality of areas.

15. A physical storage device having stored therein computer-executable instructions which, when executed by one or more hardware processors of a computing system, determine whether an image is a duplicate of another image by:
receiving the image into a memory;
dividing the image into a plurality of areas;
determining an average value for each area;
storing all the average values in a signature;
comparing at least a portion of the signature with at least a portion of other signatures stored in a database; and
determining that the image is a duplicate image when the portion of the signature matched the portion of a second signature stored in the database.

16. The physical storage device of claim 15, wherein the average value is an average of pixel values.

17. The physical storage device of claim 16, wherein the average value includes an average red pixel value, an average green pixel value, and an average red pixel value.

18. The physical storage device of claim 15, wherein the average value is a hash value of only pixel values.

19. The physical storage device of claim 15, wherein the signature comprises a string of values, wherein the database associates each signature with a location of an image corresponding to the signature.
